(19) United States
(12) Patent Application Publication
(10) Pub. No.: US 2025/0164662 A1
(43) Pub. Date: May 22, 2025

(54) XRF BOREHOLE PROBE SYSTEM AND METHOD FOR OPERATING AN XRF BOREHOLE PROBE

(71) Applicants: Helmholtz-Zentrum Potsdam - Deutsches GeoForschungsZentrum GFZ - Stiftung des Öffentlichen Rechts, Potsdam (DE); J&C Bachmann GmbH, Pfinztal (DE)

(72) Inventors: Ulrich Harms, Berlin (DE); Jochem Kück, Potsdam (DE); Marco Groh, Michendorf (DE); Claus Bachmann, Bad Wildbad (DE); Jan Bachmann, Pfinztal (DE)

(21) Appl. No.: 19/034,516

(22) Filed: Jan. 22, 2025

Related U.S. Application Data
(63) Continuation of application No. PCT/EP2023/070144, filed on Jul. 20, 2023.

(30) Foreign Application Priority Data
Jul. 22, 2022 (DE) 10 2022 207 531.5

(51) Int. Cl. G01V 5/12; G01V 5/04

(52) U.S. Cl. CPC G01V 5/12; G01V 5/045

(57) ABSTRACT

An XRF borehole probe system and a method of operating an XRF borehole probe system are provided. The XRF borehole probe system includes at least a probe body, an X-ray radiation source arranged in the probe body, a detector for fluorescence and/or scattered radiation, the detector being arranged in the probe body, an evaluation device configured to evaluate the output signals generated by the detector, the evaluation device being configured for element analysis of the irradiated material, and the evaluation device being additionally configured to determine the specific density of the irradiated material and/or to determine the distance between the probe body and a borehole wall.

### CROSS REFERENCE TO RELATED APPLICATIONS

This application is a continuation application of international patent application PCT/EP2023/070144, filed Jul. 20, 2023, designating the United States and claiming priority from German application 10 2022 207 531.5, filed Jul. 22, 2022, and the entire content of these applications is incorporated herein by reference.

### TECHNICAL FIELD

The disclosure relates to an X-ray fluorescence (XRF) borehole probe system and a method for operating an XRF borehole probe.

### BACKGROUND

In order to determine whether the extraction of minerals is economically favorable, the chemical and mineralogical composition of rocks is analyzed during mineral prospecting. For this purpose, a borehole may be drilled into the rock and a borehole probe may be moved up and down in the borehole, wherein a sensor on the borehole probe records signals from the probe's surroundings, which may then be analyzed to detect and measure the concentration of elements present.

X-ray fluorescence borehole probes are known which contain an X-ray radiation source and a detector for fluorescence radiation, wherein output signals from the detector are analyzed for the detection and concentration measurement explained. It is desirable to improve the detection and concentration measurement, in particular its reliability and accuracy. It is also desirable to enable detection and measurement in an environmentally friendly, safe, cost-effective and continuous manner.

Known from the prior art is RU 169 39 92 C, which discloses an X-ray radiometric borehole measurement used in the prospection and exploration of mineral deposits. This publication also describes that a molybdenum content may be determined in rocks and ores.

Also known is EP 0 184 898 A1, which discloses a survey in which radiation scattered from a borehole environment and surrounding earth information is analyzed to provide indications of certain preselected borehole and earth formation properties. The publication discloses the interpretation of detector signals to obtain indications of tool spacing.

Also known is EP 2 223 166 A2, which discloses a tool for use in the hydrocarbon industry, in particular a borehole imaging tool, which uses an X-ray generator.

CA 2 519 740 A1, which discloses the drilling of boreholes and the measurement of boreholes, is also known. In particular, the publication discloses the estimation of distances to layer boundaries.

GB 2 444 801 A discloses a device and method for evaluating a formation surrounding a borehole using an X-ray generator.

U.S. Pat. No. 4,628,202 A discloses a radioactivity borehole measurement and methods and devices for identifying the density and lithology of underground earth formations. The publication further discloses the storage of a so-called short-space count rate and the storage of a spectrum or count rate spectra.

WO 2021/108847 A1 discloses a blast hole surveying system and a modular borehole surveying tool.

### SUMMARY

It is an object of the present disclosure to provide a borehole probe system and a method for operating a borehole probe which enable reliable and accurate analysis of rock in the vicinity of a borehole probe, wherein such a system may also be realized in an environmentally friendly, safe and cost-effective manner and enables continuous measurement.

The object is achieved by an XRF borehole probe system and a method for operating an XRF borehole probe system as described herein.

The XRF borehole probe system comprises at least one probe body. This may comprise a housing, wherein components of the borehole probe system are arranged in an internal volume of the housing. The housing may also be referred to as a probe casing. The probe body, in particular the housing, may be made of metal. The probe body may have a lower end and an upper end. If the borehole probe is inserted into a borehole as intended, the lower end of the probe body is arranged below the upper end along the direction of gravity. The upper end therefore refers to the end of the probe body that is closer to the surface when it is used as intended in the borehole. At the upper end, which may also be referred to as the cable-side end and is the end opposite the lower end along a longitudinal axis of the probe body, the probe body may comprise an interface for the mechanical attachment of a cable or rope, which serves in particular to transmit a driving force to the probe body in the borehole in order to the probe body up and down in the borehole. The drive force may be generated by a corresponding device, which is usually located outside the borehole. For example, a drive cable or rope may be guided in a known manner to a drive device, such as a driven pulley, in order to generate the drive force. It is also possible that an interface for signaling and/or data transmission is arranged on the probe body at the upper end. The interface may, for example, be configured to enable a plug-in connection with a data cable, which may also be referred to as a logging cable. It is conceivable that such a data cable also serves as a drive cable or that a drive cable also serves for data transmission. For example, a drive cable may have electrical wires for signal and/or data transmission. However, it is also possible for a drive cable and a data cable to be configured separately from each other. It is possible that the probe system comprises a communication device, which is arranged in the probe body in particular and may transmit signals via the interface. In particular, this communication device may enable DSL-based communication. Of course, other forms/types of communication are also conceivable.

Furthermore, the probe body may comprise an interface for establishing an energy connection, i.e. an energy supply for components of the probe system, wherein this may also be used, for example, to charge an energy storage device of the probe system, which may be arranged in the probe body. This interface may also be located at the upper end. The probe system may therefore be a battery-operated probe system, wherein the energy storage device of the probe system, which may be arranged in the probe body, supplies components of the probe system with electrical energy.

Furthermore, the borehole probe system comprises exactly one X-ray radiation source or several X-ray radiation sources, which is arranged in the probe body. This is used to generate X-rays, which are then emitted into an environment of the probe body. Preferably, the radiation source is configured as an X-ray tube, wherein a target material of the X-ray tube may be, for example, molybdenum, but also rhodium or another material known to the skilled person. In particular, the target material may be an anode material of the X-ray tube, onto which electrons accelerated under high voltage from a cathode of the X-ray tube impinge. The mode of operation of an X-ray tube is known to the person skilled in the art. However, it is also possible for the X-ray radiation source to be a piezo-effect-based X-ray radiation source or a laser-based X-ray radiation source.

It is possible that the probe body has one or more X-ray radiation windows through which radiation generated by the X-ray radiation source may escape from the probe body to an environment.

The borehole probe system also includes a detector for fluorescence and/or scattered radiation. The fluorescence radiation is excited by the X-ray radiation generated by the X-ray radiation source. The scattered radiation refers to the portion of the radiation generated by the X-ray source that is scattered towards the detector and may also include or be gamma radiation. The material irradiated by the X-ray radiation source, which emits the fluorescent radiation described above and/or scatters scattered radiation when irradiated, may be the borehole fluid or the rock drilled through, i.e. the material surrounding the borehole. The detector is also located in the probe body, in particular in the housing. It is conceivable that the fluorescence radiation as well as the scattered radiation from the environment enters the probe body through the X-ray radiation window described above and is then detected by the detector. However, it is also possible that the probe body comprises several X-ray radiation windows, wherein, for example, a first X-ray radiation window is arranged and/or configured such that radiation generated by the X-ray radiation source may be emitted into the environment, while a further X-ray radiation window may be configured and/or arranged such that X-ray and/or scattered radiation may be emitted from the environment to the detector.

Furthermore, the borehole probe system comprises an evaluation device for evaluating the output signals generated by the detector, wherein the evaluation device is configured for element analysis of the irradiated material. An evaluation device may be configured as a microcontroller or integrated circuit or comprise one of these. In particular, the evaluation device may comprise a so-called multi-channel analyzer. This is used in a known manner to measure a statistically distributed sequence of electrical pulses of varying amplitude in order to determine their frequency distribution. Based on the output signals of such a multi-channel analyzer, a spectrum of the detected radiation may be determined, e.g. in the form of a histogram. It is also possible that the evaluation device comprises a digitization device which digitizes the output signals of the detector, in particular in such a way that a computer-implemented signal analysis of the generated output signals may be carried out. Such a digitization device may be configured in particular as an ADC converter.

The evaluation device may also be configured for element analysis, which includes, for example, element detection/identification and, if necessary, element quantification. This means that a chemical composition of the material of the borehole wall and/or the borehole fluid may be analyzed. The element analysis may be carried out based on the spectrum, i.e. a spectral profile, of the radiation detected by the detector. In particular, so-called spectral lines in a low-energy range, preferably a range from 0 keV (exclusive) to 45 keV (inclusive), may be used for the analysis. However, the range may also extend from 0 keV (exclusively) to a value greater than 45 keV. A spectral line may be defined as a local maximum in the spectrum. A spectral line may be assigned an intensity and a width. The spectral line may therefore comprise a (narrow) frequency range whose half-width may be described as the width of the spectral line.

According to the disclosure, the evaluation device is additionally configured to determine a specific density of the irradiated material. Alternatively or cumulatively, the evaluation device is configured to determine a distance between the probe body and a borehole wall.

The specific density may be determined from the spectral profile of the detected radiation, in particular from a profile curve and/or a profile property. In particular, the so-called bremsstrahlung may be identified in the spectral profile, wherein the specific density is determined as a function of the profile and/or properties, e.g. an intensity maximum, of the bremsstrahlung, especially since the energetic maximum of the bremsstrahlung also varies with the specific density. The determination of the specific density may preferably be assignment-based. In addition, different specific densities may be assigned to different profiles or properties, for example as part of a calibration or as a result of preliminary tests. This information, i.e. information about the specific density, the profile or the properties and their assignment to each other, may then be stored, in particular in a storage device of the probe system, for example in the form of a database. It is then possible to determine a spectral profile of the detected radiation, in particular the bremsstrahlung, or its property or properties, and then to determine the specific density as the specific density associated with a profile or property that does not deviate by more than a predetermined amount from the signal-based specific profile/property.

The specific density determined in this way may then be used to characterize the lithology, but also to correct the element analysis of the rock drilled through. In particular, a density-related scattering component of the detected radiation may be taken into account in the element analysis, as it represents a specific property of the irradiated material. The intensity, in particular the spectral intensity, of the detected radiation changes depending on the specific density of the irradiated material. The higher the specific density, the lower the intensity will be. It is therefore possible to change the intensity of the detected radiation depending on the density if the specific density is known. For example, the intensity may be increased more for a higher specific density than for a comparatively lower specific density. The element analysis may then be carried out on the basis of or as a function of the density-dependent corrected/changed intensity.

The specific density may also be used for elemental analysis of the borehole fluid. In other words, the material of the borehole fluid may be determined as a function of the specific density. Furthermore, a hydraulic property or property change in the borehole, e.g. an inflow or outflow of borehole fluid, may be determined, in particular detected, as a function of the specific gravity. In this way, it is also possible to generate location-referenced information on inflows or outflows in the borehole. Here, location-referenced information refers to information to which location information is assigned. The location information may be determined in a known manner, e.g. as depth information, wherein this may be determined using sensors, for example. For example, the depth information may be determined as a function of a position/angle detection device of a rope/cable encoder device, which sets the length of the rope/cable in the borehole and thus the depth. It is also conceivable that an acceleration sensor is used to determine the position. Depth information may also be determined using a pressure sensor, wherein the depth is determined as a function of the detected pressure.

The distance may be determined as a function of a height, i.e. a line intensity, of exactly one or more characteristic, in particular anode material-specific, spectral lines in the spectral profile of the detected radiation. For example, the line intensity may be determined at one or more predetermined frequencies or frequency ranges, in particular those specific to the anode material and thus to the radiation source, wherein the distance is then determined as a function of this/these line intensities.

This determination may also be assignment-based, wherein different distances are assigned to different heights of characteristic spectral lines, e.g. in a calibration procedure or in corresponding preliminary tests. It may be assumed that different heights may be detected for different distances. Alternatively, the distance may also be determined based on triangulation. In this case, the distance from the borehole wall may be determined as a function of a predetermined or determinable angle of incidence of the emitted X-rays on the borehole wall and a position of an intensity maximum generated by the reflected radiation in a detector surface. Corresponding triangulation methods are known to the person skilled in the art. It is also described that a distance measurement may be carried out mechanically, for example via suitable measuring devices, for example via a measuring mandrel, for which purpose the system may comprise such measuring devices. In particular, these may be arranged in or on the housing. Such a distance measurement may, for example, be carried out additionally and used to correct or improve the distance measurement.

The distance may also be used to correct the fluorescence-based element analysis, in particular by taking into account distance-related scattering and attenuation of the radiation. In particular, this distance-related scattering and attenuation may be compensated for or factored out. The intensity, in particular the spectral intensity, of the detected radiation changes depending on the distance. The higher the distance, the lower the intensity. It is therefore possible to change the intensity of the detected radiation depending on the distance if the distance is known. For example, the intensity may be increased more for a greater distance than for a smaller distance in comparison. The element analysis may then be carried out on the basis of or depending on the distance-dependent corrected/changed intensity.

It is also possible to classify, based on distance information, whether the analyzed radiation originates only or mainly from the rock (which may be assumed for distances smaller than a predetermined threshold value) or whether the analyzed radiation also originates from the borehole fluid with a proportion to be taken into account (which may be assumed for distances greater than or equal to the predetermined threshold value(s)). The proposed distance measurement enables an accuracy in the range of less than 1 mm.

The distance determination may also be used to detect breakouts in the borehole and/or to create a borehole profile. For example, a location-referenced localization of breakouts in the borehole and thus a borehole volume determination may be carried out.

The distance determination also makes it possible to form partial spectra and to use these to form an overall spectrum for the element analysis. For example, during a movement of the probe body in the borehole, in particular during an upward or downward movement as well as during a sideways movement, a spectrum may be determined repeatedly, in particular periodically, further in particular with a frequency of e.g. 1/ms, wherein a distance value may be assigned to the spectrum. This spectrum may then be referred to as a partial spectrum. A resulting distance-specific spectrum may then be determined from all spectra that were generated in particular in a predetermined time period and/or in a predetermined position range and to which the same distance value is assigned or whose assigned distance values do not deviate from each other by more than a predetermined amount, e.g. by means of suitable averaging or fusion. The resulting distance-specific spectrum, in particular the intensities in the spectrum, may then be corrected depending on the distance, as explained above. A total resultant spectrum may then be determined from all the distance-corrected resultant spectra, e.g. by suitable averaging or fusion, wherein the total resultant spectrum may then be used for element analysis.

The determination of the specific gravity and/or the distance may be location-referenced. If the output signals are also determined in a location-referenced manner, the specific gravity and/or the distance may be taken into account in the element analysis depending on the location, particularly in the case of a subsequent evaluation or an evaluation off site, e.g. in a laboratory.

The proposed borehole probe system thus advantageously enables accurate and reliable element analysis, in particular accurate and reliable element identification and concentration determination. By analyzing the output signals of the detector to determine the density and/or the distance, this improvement may also be made possible in a continuous measurement. At the same time, a safe and environmentally friendly determination is made possible. A location-referenced element analysis may also be carried out.

It is also possible that the probe body comprises or forms at least one decentration means which ensures a decentralized arrangement of the probe body in the borehole. For example, the probe system, in particular the probe body, may have or form at least one spring arm, which is arranged and/or formed in such a way that a probe body, which is inserted into a borehole, is pressed against the borehole wall by the at least one spring arm and is thus arranged decentrally in the borehole.

In a further embodiment, the evaluation device is arranged in the probe body, in particular in the housing of the probe body. In this case, the evaluation therefore takes place in the probe body. Thus, an XRF borehole probe is described which comprises the probe body, the X-ray radiation source, the detector and the evaluation device. This results in a precise and reliable signal evaluation in an advantageous manner, in particular for determining the specific density and/or the distance, as output signals from the detector device do not have to be transmitted to an evaluation device outside the probe body, which reduces transmission losses and therefore signal quality may be maintained.

In a further embodiment, the XRF borehole probe system comprises at least one high-voltage source for supplying power to the radiation source, with the high-voltage source being arranged in the probe body. The high-voltage source may generate operating voltages for the radiation source of up to 50 kV or even operating voltages greater than 50 kV. This advantageously means that no means are required to transmit the operating voltage from a voltage source outside the probe body to the radiation source in the probe body, which in turn enables simple operation of the borehole probe system.

In a further embodiment, the high-voltage source is arranged along a central longitudinal axis of the probe body closer to an upper end of the probe body than the radiation source and/or than the detector and/or than the evaluation device. This enables efficient cooling of the high-voltage source and, in particular, reduces the thermal load on the detector and/or the evaluation device. This is particularly the case since thermal energy generated by the radiation source and/or the high-voltage source is dissipated upwards by convection during intended operation. Overall, the reliability of the operation of the proposed borehole probe system is therefore improved in an advantageous manner.

In a further embodiment, the XRF borehole probe system comprises a storage device for storing signals, in particular the pulses described above, which are registered by the detector. In particular, these signals may be stored in a time-referenced manner. Thus, for example, it is possible to store which signal/pulse was detected at which time. It is also possible to store an energy level, for example in keV, of the registered signal. The storage device is also located in the probe body. This advantageously enables the registration of (X-ray) photons and, in particular, the signal changes triggered by these in the detector, e.g. in the form of voltage pulses. These signal changes may be assigned a time stamp, for example, which is also stored. This advantageously simplifies subsequent evaluation, for example evaluation off site, i.e. outside the borehole. By storing additional information, it is advantageous that data may be analysed at a later point in time and, in particular, assigned to location information, even if the data connection is disrupted or interrupted.

The memory device described, or a further memory device may (also) be used to store data or data sets processed by the evaluation device, wherein a further memory device may also be arranged in the probe body. For example, a spectrum or a part thereof may be stored, which was determined by analyzing the detected signals. It is also possible to store the specific density and/or the distance as explained. In particular, this may be done in a location-referenced manner, wherein the corresponding information may be assigned location information, for example a spatial position, in particular depth information, and may also be stored. Of course, it is also conceivable that an element is identified and/or an element concentration is determined, and corresponding element information is stored. The information stored in this way may be transmitted from the storage devices in the probe body to an external system, in particular via the data and/or signal interface described above.

In a further embodiment, the XRF borehole probe system comprises at least one X-ray radiation window, which is arranged in an outer wall of the probe body. This has already been explained above. The X-ray radiation window is made of a material that is transmissive to X-rays. Such a material may be, for example, but not exclusively, PP, PEEK, TPU, borosilicate or diamond or a combination of at least two of these materials. It is also possible for the material to be a combination of one of the materials listed with at least one other material not explicitly listed. Furthermore, the X-ray window has a hydrophobic outer surface or is coated with a hydrophobic layer. The coating may be a nanocoating. In particular, the surface may therefore provide a lotus effect, which means that this outer surface may only be wetted by liquids to a very small extent. The micro-and nanoscopic architecture of the surface may be configured accordingly. This advantageously enables the emission of X-rays from the probe body to be influenced as little as possible by liquids, which in turn improves the accuracy and reliability of the element analysis.

Alternatively or cumulatively to the hydrophobic outer surface, the outer surface of the X-ray radiation window is coated with an aerogel material. In particular, the coating with the aerogel material may be configured in such a way that an aerogel pad is glued to the X-ray radiation window or otherwise attached to it. The thickness of the coating may be up to 1 mm. In this context, an aerogel may refer to an open-pored, nanostructured material. In particular, a hydrophobic aerogel material may be used for the coating. It is possible for a predetermined percentage of the volume of the aerogel material, for example up to 95%, to consist of pores. Preferably, the aerogel material is a silicate-based material. This also advantageously results in a low influence on the radiation emitted from the probe body.

Further alternatively or cumulatively, the X-ray radiation window is stabilized by a support structure. The support structure may be honeycomb-like and/or comprise support webs, wherein a mechanical strength or mechanical rigidity of the X-ray radiation window with the support structure is greater than that of the X-ray radiation window without the support structure. The mechanical strength or mechanical rigidity of the support structure may also be greater than the remaining window material. The material of the support structure may also be transmissive for X-rays. It is possible for the support structure to be made of the same material as the remaining window material, although the support structure may have different mechanical properties than the remaining material. This advantageously results in high stability of the X-ray radiation window and thus high operational reliability during operation of the borehole probe system.

In a further embodiment, the XRF borehole probe system comprises at least one gas outlet, wherein the gas outlet is arranged and/or configured such that a gas curtain or gas cushion may be generated in front of the X-ray radiation window by the outlet of gas from the gas outlet. The gas may in particular be air or an inert gas. The outlet may be arranged in such a way that gas flows past the X-ray radiation window when the probe is used/inserted into a borehole as intended. For example, the outlet may be arranged along the central longitudinal axis of the probe body closer to a lower end of the probe body than the X-ray radiation window. In this case, outflowing gas may flow past the X-ray radiation window due to the buoyancy. This also has the advantage that radiation emitted from the probe body by the radiation source is influenced as little as possible by borehole material.

It is also possible that the borehole probe system, in particular the probe body, has or forms a retention device that extends the time until the gas escapes from a spatial volume in front of the X-ray radiation window compared to a configuration without a retention device. Such a retention device may, for example, be configured as a structure protruding from the outside of the probe body.

If the borehole probe system comprises a gas outlet, it is possible that the proposed system also comprises at least one further pneumatic device, for example a pump and/or a gas accumulator, which may be pneumatically connected to the gas outlet. The further pneumatic device may also be arranged in the probe housing.

It is also possible that the borehole probe system comprises a device for generating gas from the borehole fluid. This device may also be arranged in the probe body and be fluidically connected to the gas outlet. The advantage of this is that less installation space is required, as no gas storage tank is required to supply the gas outlet, but gas may be generated directly from the borehole fluid.

In a further embodiment, the XRF borehole probe system, in particular the probe body, has or forms at least one brush element for cleaning the borehole wall. Such a brush element may be used in particular to scrape or scrape off the so-called filter cake and advantageously enables a more reliable and accurate element analysis of the rock, as the borehole material does not influence the signal generation or influences it to a lesser extent. This also applies in particular to an electrical, acoustic or optical measurement of the rock.

In a further embodiment, the at least one brush element is arranged movably relative to the probe body. For example, the brush element may be movably mounted on/in the probe body. It is possible that the brush element is a driven brush element, for example a rotating or linearly movable brush element. A corresponding drive device may be part of the borehole probe system and, in particular, be arranged in the probe body. Alternatively, the brush element is stationary relative to the probe body. In this case, it may be mechanically rigidly arranged on the housing, for example.

Alternatively or cumulatively, the at least one brush element is arranged along a central longitudinal axis of the probe body closer to an upper end or closer to a lower end of the probe body than an X-ray radiation window in the probe body. Preferably, the brush element is arranged at the lower end of the probe body. This advantageously results in a reliable removal of the explained filter cake before the X-ray radiation window is moved past the cleaned area of the borehole wall during an upward or downward movement, whereby the radiation emitted from the probe body is influenced as little as possible by the filter cake.

In a further embodiment, the XRF borehole probe system comprises at least one light source and at least one light detector for hyperspectral material analysis. In particular, the light source may be an infrared light source, and the light detector may be an infrared light detector. The wavelength of the infrared radiation may be in the range from 400 nm to 2000 nm. In this case, the evaluation device or another evaluation device of the borehole probe system may be configured for hyperspectral material analysis. This means that a mineral analysis may also be carried out in addition to the XRF-based element analysis. It is conceivable that the light generated by the light source is radiated out of the probe body through a window which is different from the X-ray radiation window. In particular, this window may be an acrylic glass window and may be arranged closer to the lower end of the probe body than the X-ray radiation window.

Alternatively or cumulatively, the borehole probe system comprises at least one monochromatic radiation source and at least one detector for the scattered monochromatic radiation for Raman spectroscopic material analysis. In this case, the evaluation device or a further evaluation device of the borehole probe system may be configured for Raman spectroscopic material analysis. It is conceivable that the radiation generated by the monochromatic radiation source is radiated out of the probe body through a window of the probe body which is different from the X-ray radiation window.

Further alternatively or cumulatively, the borehole probe system comprises at least one optical radiation source emitting radiation with wavelengths of the hyperspectral spectrum, preferably with a wavelength from a spectrum of 350 to 800 nm, and at least one detector for the scattered radiation generated by the optical radiation source for material analysis based on optical fluorescence. The spectral resolution may be in the range of nm, e.g. in the range of 3 nm to 10 nm. In this embodiment, the evaluation device or a further evaluation device of the borehole probe system may be configured for material analysis based on optical fluorescence. It is conceivable that the radiation generated by the optical radiation source is radiated out of the probe body through a window of the probe body which is different from the X-ray radiation window.

The output signals generated by the at least one detector described above and/or the information generated by an evaluation device by means of material analysis may be stored in the aforementioned storage device or a further storage device of the borehole probe system, in particular in a location- and/or time-referenced manner, e.g. in order to enable evaluation off site, e.g. in the laboratory.

It is also possible that the information generated by the explained material analysis and the element information determined by the element analysis based on the explained fluorescence and/or scattered radiation are stored in a mutually associated manner.

Furthermore, the proposed borehole probe system may comprise at least one fan, which may be arranged in the probe body in particular. The fan may be arranged below or above a circuit board, with the evaluation device being arranged on the circuit board.

It is also possible that the borehole probe system comprises or forms a cooling container, which may be arranged in the probe body in particular. In particular, this cooling container may be arranged at a lower end of the probe body. The cooling container is used to hold a cooling material, for example ice. Furthermore, the cooling container may be part of a cooling system of the borehole probe system, in particular of the probe body. The cooling system may comprise at least one cooling finger, which is, for example, thermally connected to the cooling container, in particular to the cooling material in the cooling container. The cooling finger may be used to cool the air in the probe body. As a result, the borehole probe system may also be used at high ambient temperatures and enable reliable and accurate material analysis.

It is also possible that the borehole probe system comprises at least one fan, wherein this may be arranged in particular in the probe body. The at least one fan is arranged and/or configured in such a way that a carrier board and components arranged thereon/thereon, e.g. the evaluation device and/or the storage device, may be flowed against by an air flow generated by the fan for cooling. In particular, one or more fans may be arranged and/or configured in such a way that a circular air flow may be generated around the carrier board, i.e. also above and below the carrier board.

In a further embodiment, the borehole probe system comprises a water sensor for detecting a state of the probe body in water. This water sensor may, for example, generate a first output signal when the probe body is under water and generate further output signals when the probe body is not under water. If the first output signal is generated, a gas outlet from the previously explained outlet opening may be activated, for example. An evaluation may also be adapted to an underwater condition.

This results in a more accurate and reliable material analysis when using the borehole probe system under water.

It is possible that all components in the probe housing are arranged with a predetermined spatial relative arrangement to each other, which may then be taken into account during evaluation, in particular during element and mineral analysis.

A method for operating an XRF borehole probe system according to one of the embodiments described in this disclosure is proposed. Here, a specific density of the irradiated material and/or a distance between the probe body and a borehole wall is determined as a function of the output signals generated by the detector. This and the corresponding technical advantages have already been explained above. Of course, in addition to determining the specific density and/or the distance, an element analysis, in particular the element identification and concentration determination described above, may also be carried out as a function of the output signals generated by the detector.

In a preferred embodiment, an elemental analysis is performed to take into account or as a function of specific gravity and/or distance. As explained above, the specific density and/or the distance may affect the spectral profile of the radiation received by the detector. If the specific density and/or distance is known, the spectral profile may be corrected, which in turn enables a more accurate and reliable elemental analysis.

In a further embodiment, output signals from the detector are stored, in particular in a time-referenced manner. This and the corresponding technical advantages have already been explained above.

In a further embodiment, radiation is generated from a radiation source of the borehole probe system that is different from the X-ray radiation source. This radiation is emitted. As explained above, the radiation may be infrared radiation, monochromatic radiation or optical radiation. The scattered radiation may be detected, and a material analysis may be carried out depending on the detected radiation. This and the corresponding advantages have already been explained above.

### BRIEF DESCRIPTION OF THE DRAWINGS

The disclosure will now be described with reference to the drawings wherein:

FIG. 1 shows a schematic longitudinal section through a borehole probe system according to an exemplary embodiment of the disclosure,

FIG. 2 shows a schematic longitudinal section through a borehole probe system according to a further exemplary embodiment of the disclosure,

FIG. 3 shows a schematic cross-section through a probe body in the area of the X-ray radiation source,

FIG. 4 shows a further schematic cross-section through a probe body in the area of the X-ray radiation source,

FIG. 5 shows a schematic cross-section of a probe holder,

FIG. 6 shows a perspective view of a brush element,

FIG. 7 shows a further schematic longitudinal section through a probe body in the area of an X-ray radiation window,

FIG. 8 shows a perspective view of an X-ray radiation window,

FIG. 9 shows a schematic block diagram of a borehole probe system according to a further exemplary embodiment of the disclosure, and

FIG. 10 shows a schematic flow diagram of a method according to an exemplary embodiment of the disclosure for operating a borehole probe system.

### DESCRIPTION OF EXEMPLARY EMBODIMENTS

In the following, identical reference signs denote elements with identical or similar technical features.

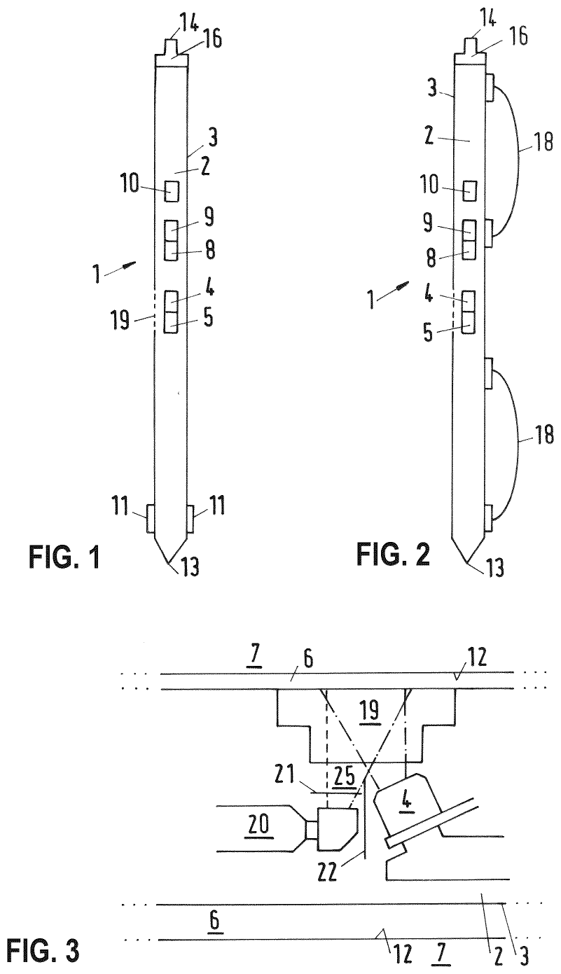

FIG. 1 shows a schematic longitudinal section through a probe body 2 of an XRF borehole probe system 1 according to an exemplary embodiment of the disclosure. The probe body 2 comprises a probe sheath tube 3 and an X-ray radiation window 19, which is arranged in the probe sheath tube 3 and permits transmission of X-rays from the interior of the probe sheath tube 3 into the environment as well as transmission of X-rays and/or scattered radiation from the environment into the interior of the probe sheath tube 3. The borehole probe system 1 further comprises an X-ray radiation source 4, which is arranged in the probe body 2, in particular the probe casing tube 3, and a detector 5, which is also arranged in the probe body 2 and is configured to detect fluorescent radiation excited by emitted X-rays and/or X-rays scattered by the environment (scattered radiation), the emitted radiation being generated by the X-ray radiation source 4. In other words, the X-ray radiation source 4 generates the X-rays and emits them into an environment of the probe body 2, in particular into a borehole fluid 6 and into the rock 7 drilled through (see FIG. 3). In a dry borehole, the radiation is emitted into the air in the borehole. Fluorescent radiation is then excited in the borehole fluid 6 or the air and/or the rock 7 and/or the emitted X-rays are scattered and radiated back to the probe body 3, wherein this radiation is then detected by the detector 5. The borehole probe system 1 also comprises an evaluation device 8, which is also arranged in the probe body 2. Also shown is a storage device 9, which is also arranged in the probe body 3 and is connected to the evaluation device 8 for data processing.

Furthermore, the borehole probe system comprises a high-voltage source 10, which generates or provides an operating voltage for the X-ray radiation source 4, which may be configured in particular as an X-ray tube, preferably as a molybdenum X-ray tube.

The borehole probe system also comprises brush elements 11, which are arranged on an outer side of the probe casing tube 3 and are used to clean the borehole wall 12 (see FIG. 3).

FIG. 1 shows a lower end 13 and an upper end 14 of the probe body 2, wherein the upper end 14 is the end of the probe body 2 closer to the surface when the probe body 2 is used as intended in the borehole 15 (see e.g. FIG. 9). An interface 16 for the mechanical attachment of a retaining cable 17 (see also FIG. 9) and for establishing a signal connection with an external system, e.g. for connecting a so-called logging cable, is arranged at the upper end 14 of the probe body 2. It is possible that the retaining cable 17 has electrical wires that are suitable for signal transmission, whereby the retaining cable 17 forms the aforementioned logging cable. FIG. 1 shows that the X-ray radiation source 10 is arranged along a central longitudinal axis of the probe body 2 closer to the upper end 14 of the probe body a2 than the radiation source 4, the detector 5 and the evaluation device 8.

The evaluation device 8, which may comprise a microcontroller or an integrated circuit or be configured as such, may evaluate the output signals generated by the detector 5. In particular, a spectrum of the radiation received by the detector 5 may be determined by the evaluation. For this purpose, the evaluation device may comprise a multi-channel analyzer. Furthermore, the evaluation device 8 may perform an elemental analysis of the irradiated material, in particular based on the spectrum and its properties. In particular, the analyzer 8 may identify an element and determine its concentration in the irradiated material.

In addition, the evaluation device 8 is configured to determine the specific density of the irradiated material. Alternatively or cumulatively, the evaluation device 8 is configured to determine the distance between the probe body 2 and the borehole wall 12. The element analysis described above may be carried out as a function of the specific density determined by the evaluation device 8 and/or as a function of the distance determined by the evaluation device 8. The storage device 9 is used to store the signals registered by the detector 5, in particular in a time-referenced manner. The storage device 9 or another storage device not shown may also be used to store data or data records already processed by the evaluation device 8.

FIG. 2 shows a schematic longitudinal section through a probe body 2 in a further exemplary embodiment. In contrast to the embodiment shown in FIG. 1, the borehole probe system 1, in particular the probe body 2, comprises spring elements 18 for decentering the probe body 2 in a borehole 15. In the embodiment shown in FIG. 2, the spring elements 18 are configured as arc spring elements, with the two ends of a spring element 18 attached to the outside of the probe casing tube 3. Furthermore, the arc spring elements 18 protrude from the outside. During insertion into a borehole 15 (see FIG. 9), the spring elements 18 press the probe body 2 against the borehole wall 12. This may advantageously ensure that as little borehole fluid 6 as possible is located between the X-ray radiation window 19 and the borehole wall 12. For this purpose, the spring elements 18 are arranged on a partial area of the outside of the probe casing tube 3, which is opposite the area with the X-ray radiation window 19.

FIG. 3 shows a schematic cross-section through a section of the probe body 2. An X-ray tube 20 is shown, which emits X-rays through a slit aperture 21 and out of the probe body 2 through an X-ray window 19. A primary beam path 25 of an emitted X-ray is shown framed by a dashed line. Also shown is a detector 4 and a detection area of the detector 4 enclosed by a dotted line, which receives radiation entering the probe body 2 from outside through the X-ray window 19, in particular fluorescent and/or scattered radiation, which is excited in the irradiated material by the X-rays generated by the radiation source 5.

The drilled-through rock 7 and a borehole fluid 6, which is arranged between the probe body 2 and the borehole wall 12 formed by the drilled-through rock 7, are also shown. Also shown is a shield plate 22, which is arranged between the X-ray tube 20 and the detector 4 and prevents radiation emitted by the X-ray tube 20 from being received by the detector 4. It is possible for the X-ray tube 20 and the detector 4 to be arranged offset to one another along a transverse axis of the probe body 2, which may be orientated perpendicular to the drawing plane, for example. This means that detection areas may also be arranged offset to each other along this transverse axis.

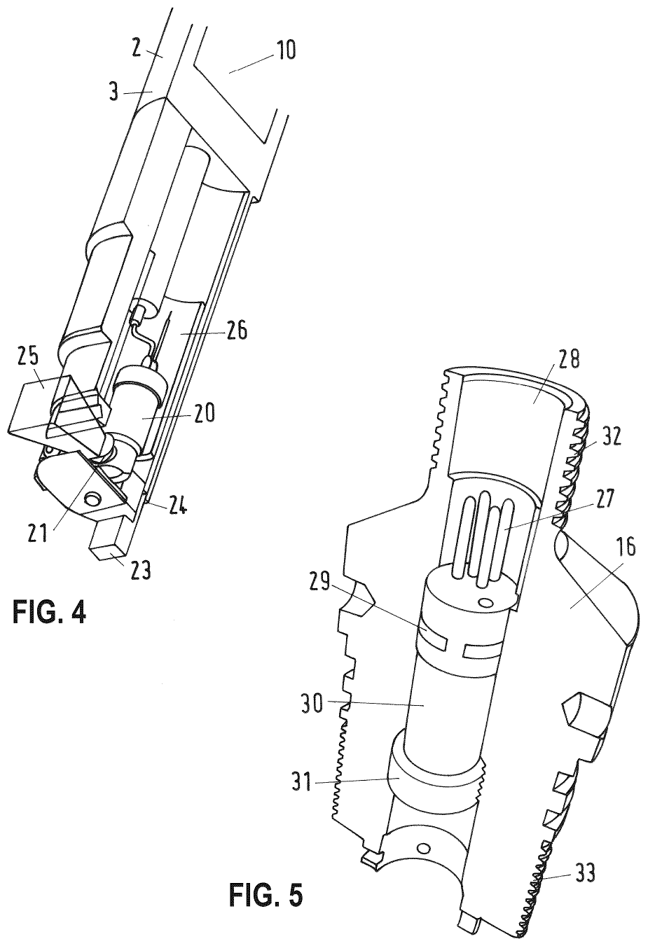

FIG. 4 shows a schematic cross-section through a probe body 2 in a further exemplary embodiment. The X-ray tube 20 is again shown, which may be configured as a side window tube, for example. An anode of the X-ray tube may be connected to a reference or ground potential, which may be, for example, the potential of the probe sheath 3. A cathode may be connected to a high-voltage source 10. Also shown is an interface 23 for controlling a high-voltage source 10, which may provide a fiber optic cable connection and a connection for the electrical supply of the high-voltage source 10. This is connected to the high-voltage source 10 via a cable duct 24. A carrier board of the interface 23 may also be arranged in the cable duct 24. Also shown is the slit aperture 21, which may be made of molybdenum, for example. A beam path 25 generated by the X-ray tube 20 is shown schematically. Also shown is a mica tube 26 in which the X-ray tube 20 is arranged and which is completely molded for electrical insulation.

FIG. 5 shows a schematic cross-section of an interface 16, which may be arranged at the upper end of a probe body 2 (see e.g. FIG. 1). The interface 16 comprises a 4-pole connection device 27, which is arranged in a through-opening 28 formed by the interface 16. It is also shown that the 4-pole connection device 27 is connected to an externally threaded element 31 via a sealing ring 29 and a spacer 30. The externally threaded element 31 may be screwed into an internal thread of the interface 16 arranged in the through-opening 28. Also shown are externally threaded sections 32, 33 of the interface 16, wherein a first external thread 32 is used to connect a holding and logging cable 17 (see FIG. 9) and a second external thread 33 is used to screw the interface 16 into the probe body 2. The interface 16 may be made of titanium.

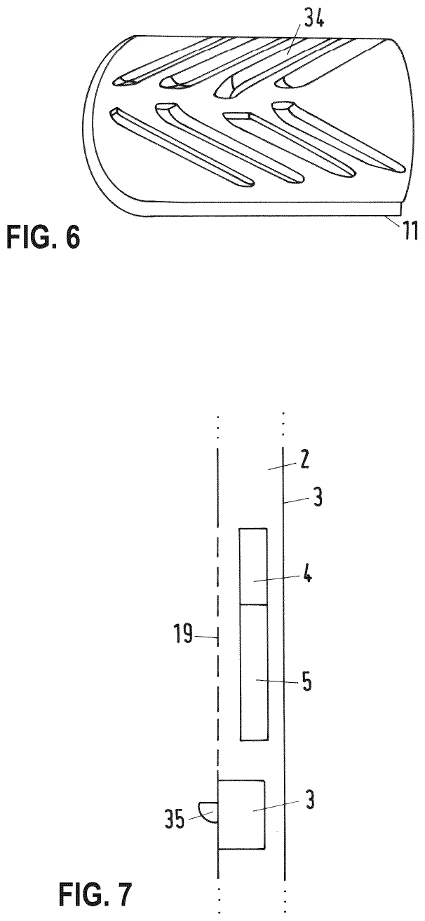

FIG. 6 shows a perspective view of a brush element 11. This brush element 11 has grooves 34 or notches on an outer surface, the central center axes of which are oriented obliquely to a central longitudinal axis of the brush element 11. If this brush element 11 slides along a borehole wall 12 (see e.g. FIG. 3), material scraped from the borehole wall 12 may enter the grooves 34 and be transported along the grooves 34.

FIG. 7 shows a schematic cross-section through a part of the probe body 2 in the area of the X-ray radiation window 19. A gas outlet element 35 is shown, which is fluidically connected to a gas reservoir 36 arranged in the probe body 2. The gas outlet 35 is arranged here, purely by way of example, on an outer side of the probe sheath tube 3. If the gas outlet 35 is fluidically connected to the gas reservoir 36 and pressurized with gas, the gas outlet 35 generates a gas curtain or a gas cushion in front of the X-ray radiation window 19, in particular in front of an outer side of the X-ray radiation window 19.

Alternatively or cumulatively, to provide such a gas curtain or gas cushion, the X-ray radiation window 19 may have or form a hydrophobic outer surface or be coated with a hydrophobic layer. Further alternatively or cumulatively, the X-ray radiation window 19, in particular an outer surface, may be coated with an aerogel material.

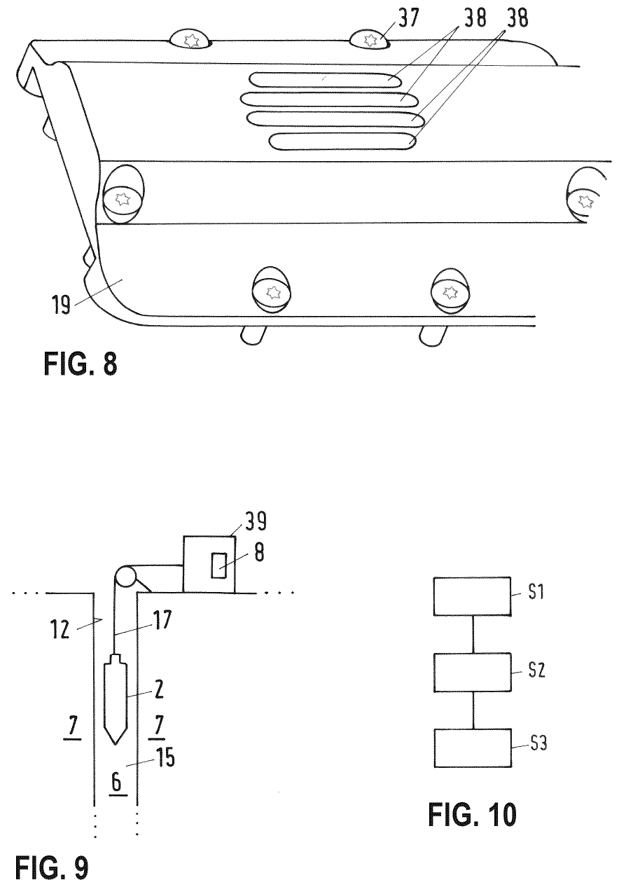

FIG. 8 shows a perspective view of an X-ray radiation window 19, which is made of a material that is transmissive to X-rays. Screws 37 for the mechanical connection of the X-ray radiation window 19 to the probe body 2 are shown. Support grid elements 38, which improve the mechanical stability of the X-ray window 19, are also shown schematically.

FIG. 9 shows a schematic block diagram of an XRF borehole probe system 1 according to a further exemplary embodiment of the disclosure. A probe body 2 is shown, which may comprise an X-ray radiation source 4 (not shown) and a detector 5 (also not shown) (see FIG. 1). The probe body 2, in particular the components arranged in the probe body 2, is connected to an external system 39 via a logging cable 17, which also forms a holding cable of the probe body 2. This external system 39 comprises, for example, a drive device for transmitting a tensile force to the holding and logging cable 17. Furthermore, the external system may comprise an evaluation device 8, which is connected via the holding and logging cable 17 to, for example, the detector 5 of the probe body 2 in terms of data and/or signals. This evaluation device 8 may be configured for the previously explained element analysis as well as for determining the specific density and/or for determining the distance between the probe body 2 and the borehole wall 11.

FIG. 11 shows a schematic flow diagram of a method according to the disclosure for operating an XRF borehole probe system 1 according to one of the exemplary embodiments described in this disclosure. Here, in a first step S1, X-rays are generated by an X-ray radiation source 4 (see e.g. FIG. 1) and emitted from the probe body 2. In a second step S2, the fluorescent radiation excited by this emitted radiation and/or the scattered radiation explained is detected by a detector 5. In a third step S3, the output signals generated by the detector 5 on receipt of this radiation are analyzed by an evaluation device 8. In the third step S3, a specific density of the irradiated material is also determined by the evaluation device 8. Alternatively or cumulatively, a distance between the probe body 2 and the borehole wall 12 is determined. Depending on the specific density and/or the distance, an element analysis of the irradiated material is then carried out by the evaluation device or by a higher-level system. Output signals generated by the detector 5 may be stored at the same time as or after the analysis, in particular in a time-referenced manner. It is also possible that information generated by the analysis is also stored.

### LIST OF REFERENCE NUMERALS

1 XRF borehole probe system
2 Probe body
3 Probe sheath tube
4 X-ray radiation source
5 Detector
6 Borehole fluid
7 Rock
8 Evaluation device
9 Storage device
10 High voltage source
11 Brush element
12 Borehole wall
13 Lower end
14 Upper end
15 Borehole
16 Interface
17 Holding and logging cable
18 Spring element
19 X-ray radiation window
20 X-ray tube
21 Slit aperture
22 Shield plate
23 Interface
24 Cable duct
25 Output
26 Mica tube
27 Connection device
28 Through-opening
29 Scaling element
30 Spacer element
31 Externally threaded element
32 External thread
33 External thread
34 Groove
35 Gas outlet
36 Gas reservoir
37 Screw
38 Support bar
39 External system
S1 First step
S2 Second step
S3 Third step

What is claimed is:

1. An XRF borehole probe system, comprising:
a probe body;
at least one X-ray radiation source arranged in the probe body;
a detector for fluorescence and scattered radiation, wherein the detector is arranged in the probe body;
an evaluation device configured to evaluate the output signals generated by the detector,
wherein the evaluation device is configured for element analysis of the irradiated material, and
wherein the evaluation device is further configured to determine the specific density of the irradiated material and/or to determine the distance between the probe body and a borehole wall.

2. The XRF borehole probe system according to claim 1, wherein the evaluation device is arranged in the probe body.

3. The XRF borehole probe system according to claim 1, further comprising:
at least one high-voltage source configured to supply energy to the X-ray radiation source, and the high-voltage source being arranged in the probe body.

4. The XRF borehole probe system according to claim 3, wherein the high-voltage source is arranged along a central longitudinal axis of the probe body closer to an upper end of the probe body than the X-ray radiation source and/or than the detector and/or than the evaluation device.

5. The XRF borehole probe system according to claim 1, wherein the XRF borehole probe system comprises:
a storage device configured to store the signals registered by the detector, in particular time-referenced signals, the storage device being arranged in the probe body.

6. The XRF borehole probe system according to claim 1, further comprising:
at least one X-ray radiation window arranged in an outer wall of the probe body,
wherein the X-ray radiation window:
is made of a material that is transmissive to X-rays, and/or
has a hydrophobic outer surface or is coated with a hydrophobic layer, and/or
is coated with an aerogel material, and/or
is stabilized by a support structure.

7. The XRF borehole probe system according to claim 1, further comprising:
at least one gas outlet, the arrangement of which realizes a gas curtain or a gas cushion in front of the X-ray radiation window when gas is supplied.

8. The XRF borehole probe system according to claim 1, wherein the XRF borehole probe system has or forms at least one brush element for cleaning the borehole wall.

9. The XRF borehole probe system according to claim 1, wherein the at least one brush element is:
movable or stationary relative to the probe body, and/or
arranged along a central longitudinal axis of the probe body closer to an upper end or closer to a lower end of the probe body than an X-ray radiation window in the probe body.

10. The XRF borehole probe system according to claim 1, further comprising:
at least one light source and at least one light detector for hyperspectral material analysis; and/or
at least one monochromatic radiation source and at least one detector for the scattered monochromatic radiation for Raman spectroscopic material analysis; and
at least one optical radiation source and at least one detector for the scattered monochromatic radiation for material analysis based on optical fluorescence.

11. The XRF borehole probe system according to claim 1, further comprising:
a water sensor configured to detect a state of the probe body in water.

12. A method for operating an XRF borehole probe system according to claim 1, the method comprising:
determining a specific density of the irradiated material and/or a distance between the probe body and a borehole wall as a function of the output signals generated by the detector.

13. The method according to claim 12, wherein an element analysis is carried out taking into account the specific density and/or the distance.

14. The method according to claim 12, wherein output signals of the detector, in particular time-referenced output signals, are stored.

15. The method according to claim 12, wherein infrared radiation is generated and emitted,
wherein scattered infrared radiation is detected and a mineral analysis is carried out as a function of the detected radiation, and/or
wherein monochromatic radiation is generated and emitted, and
wherein the scattered monochromatic radiation is detected and a material analysis is carried out as a function of the detected radiation.
